(19) United States
(12) Patent Application Publication
(10) Pub. No.: US 2026/0044775 A1
(43) Pub. Date: Feb. 12, 2026

(54) Methods for VFL operation between Application Function and 5GC

(71) Applicant: InterDigital Patent Holdings, Inc., Wilmington, DE (US)

(72) Inventors: Jung Je Son, Warrington, PA (US); Ulises Olvera-Hernandez, Saint-Lazare (CA); Guanzhou Wang, Brossard (CA); Achref Methenni, Montreal (CA); Alec Brusilovsky, Downingtown, PA (US); Michel Roy, Candiac (CA); Zhibi Wang, Woodridge, IL (US)

(73) Assignee: InterDigital Patent Holdings, Inc., Wilmington, DE (US)

(21) Appl. No.: 18/798,106

(22) Filed: Aug. 8, 2024

(51) Int. Cl. G06N 20/00

(52) U.S. Cl. CPC G06N 20/00

(57) ABSTRACT

An example method performed by a vertical federated learning (VFL) server is disclosed. The method comprises receiving information indicating a plurality of network elements associated with one or more analytics services and respective ML models supported at the plurality of network elements for the one or more analytics services, selecting one or more of the plurality of network elements as one or more VFL clients to perform VFL for an analytics service based on the received information, performing sample and feature alignment with the one or more VFL clients to obtain alignment results, and determining a VFL model for the analytics service. The VFL model includes a global ML model for the VFL server and one or more local ML models for the one or more VFL clients. The method further comprises sending an indication of a local ML model determined for each VFL client.

### BACKGROUND

Federated learning among multiple network data analytics functions (NWDAFs) is described in the third generation partnership project (3GPP). For example, the 3GPP describes how a network data analytics function (NWDAF) can leverage Federated Learning (FL) techniques to train a machine learning (ML) model.

### SUMMARY

An example method performed by a vertical federated learning (VFL) server in a wireless communication network is disclosed. The method comprises receiving information indicating a plurality of network elements associated with one or more analytics services, and respective ML models supported at the plurality of network elements for the one or more analytics services. The method further comprises selecting one or more of the plurality of network elements as one or more VFL clients to perform VFL for an analytics service based on the received information. The method further comprises performing sample and feature alignment with the one or more VFL clients to obtain alignment results. The method further comprises determining a VFL model for the analytics service. The VFL model includes a global ML model determined for the VFL server and one or more local ML models determined for the one or more VFL clients based on the alignment results. The method further comprises sending, for each VFL client of the one or more VFL clients, an indication of a local ML model determined for the VFL client.

In examples, a network element of the plurality of network elements is configured to implement a NWDAF or an application function (AF) in the wireless communication network. In examples, the VFL server is a network element configured to implement a NWDAF or an application function (AF) in the wireless communication network. In examples, the method further comprises detecting a trigger to perform VFL for the analytics service. In examples, the method further comprises sending, in response to detecting the trigger, a discovery request to receive the information indicating the plurality of network elements as a discovery response. In examples, the method further comprises updating the VFL model to remove the given sample or the given feature from the global ML model and the one or more local ML models based on the alignment results indicating that a given sample or a given feature is unavailable for data collection at a given VFL client of the one or more VFL clients. In examples, the method further comprises sending, to a given VFL client of the one or more VFL clients, an indication of ground truth data for training a given local ML model of the given VFL client. In examples, the method further comprises communicating with the one or more VFL clients to initiate VFL training of the VFL model. In examples, the method further comprises receiving, from the one or more VFL clients, local training results associated with training of the one or more local ML models. In examples, the method further comprises training the global ML model using the local training results to obtain a global training result. In examples, the method further comprises sending a request for updating a given local ML model of a given VFL client of the one or more VFL clients based on the global training result. In examples, the received information further indicates one or more characteristics of the respective ML models. In examples, the method further comprises determining, based on the received information, one or more candidate VFL models for the analytics service. In examples, determining the VFL model is further based on the determined one or more candidate VFL models. In examples, the analytics service is configured to provide analytics associated with the wireless communication network. In examples, the analytics include network data analytics that characterize network function load or network slice load. In examples, the analytics include observed service experience analytics for a particular application. In examples, the analytics include statistics or predictions based on network data collected in the wireless communication network. In examples, the statistics or predictions are associated with at least one of: base station status information, base station resource usage, communication and mobility performance in an area of interest, wireless transmit/receive unit (WTRU) mobility, or expected WTRU behavior.

An example VFL server in a wireless communication network is disclosed. The VFL server comprises a processor configured to receive information indicating a plurality of network elements associated with one or more analytics services, and respective ML models supported at the plurality of network elements for the one or more analytics services. The processor is further configured to select one or more of the plurality of network elements as one or more VFL clients to perform VFL for an analytics service based on the received information. The processor is further configured to perform sample and feature alignment with the one or more VFL clients to obtain alignment results. The processor is further configured to determine a VFL model for the analytics service based on the alignment results. The VFL model includes a global ML model determined for the VFL server and one or more local ML models determined for the one or more VFL clients. The processor is further configured to send, for each VFL client of the one or more VFL clients, an indication of a local ML model determined for the VFL client.

In examples, a network element of the plurality of network elements is configured to implement a network data analytics function (NWDAF) or an application function (AF) in the wireless communication network. In examples, the VFL server is a network element configured to implement a network data analytics function (NWDAF) or an application function (AF) in the wireless communication network. In examples, the processor is further configured to detect a trigger to perform VFL for the analytics service. In examples, the processor is further configured to send, in response to detecting the trigger, a discovery request to receive the information indicating the plurality of network elements as a discovery response. In examples, the processor is further configured to update the VFL model to remove the given sample or the given feature from the global ML model and the one or more local ML models based on the alignment results indicating that a given sample or a given feature is unavailable for data collection at a given VFL client of the one or more VFL clients.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating an example of Horizontal Federated Learning (HFL) and an example of VFL according to an embodiment.

FIG. 3 is a diagram illustrating an example process for VFL client capability registration including the registration of information associated with ML models supported by a VFL client, according to an embodiment.

FIG. 4 is a diagram illustrating an example process for VFL training with local ML model training strategies, according to an embodiment.

### DETAILED DESCRIPTION

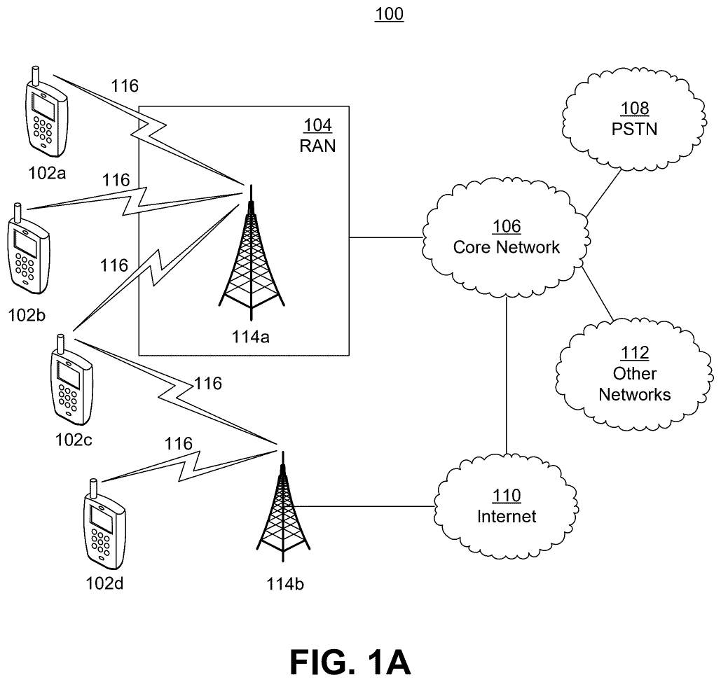

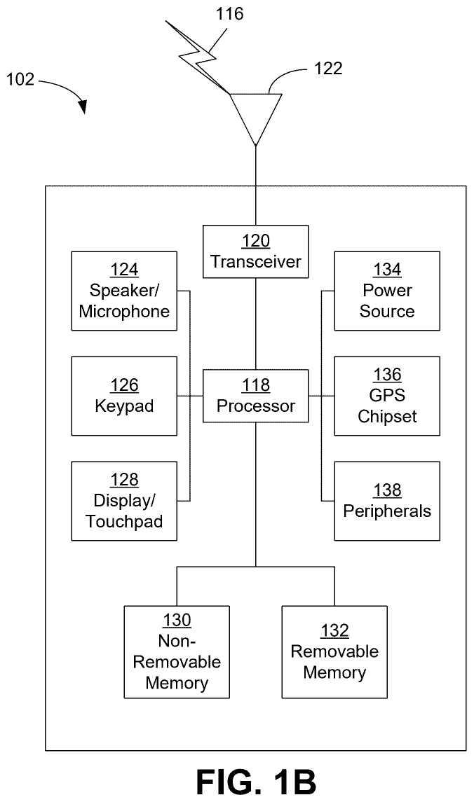

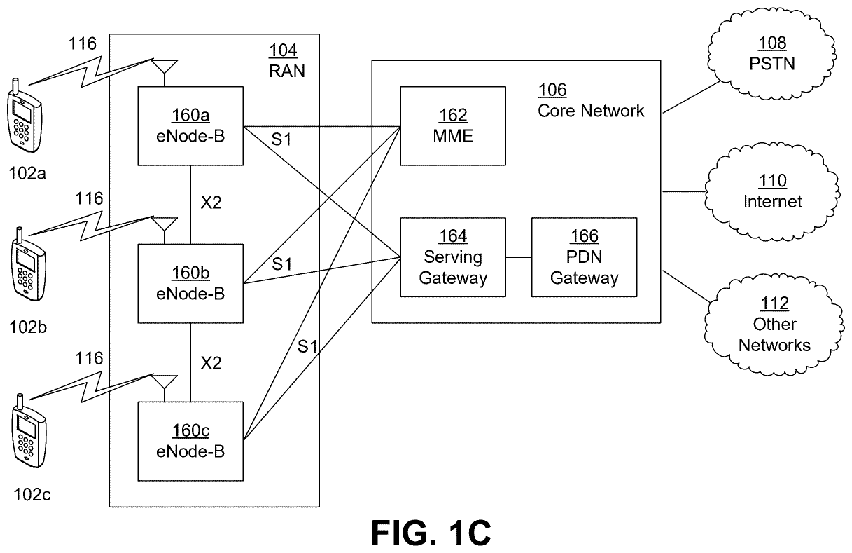

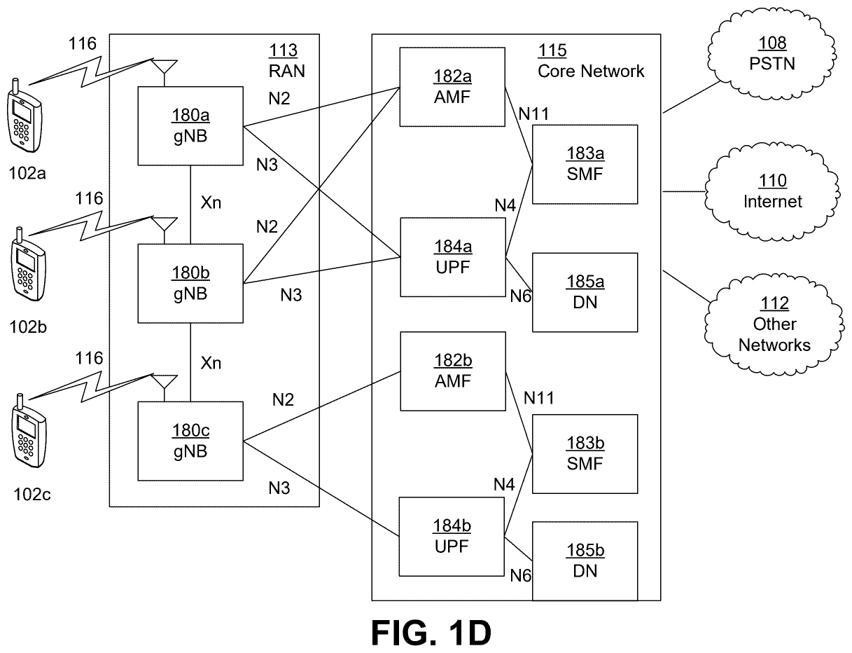

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception)) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Examples are described herein for VFL capability registration of supported ML models between application function (AF) and 5G Core (5GC).

For example, in a wireless communication network (e.g., core network 115, RAN 113, etc.), VFL clients (e.g., network elements, NWDAF, AF, base station, other network element of core network 115 or RAN 113, etc.) may be configured to register (e.g., at a network function (NF), etc.) an indication of their capability as a VFL client supporting analytics service(s), one or more supported ML models associated with one or more analytics services of a VFL client, and/or information pertaining to the supported ML models.

A VFL server may discover VFL clients for an analytics service (e.g., based on the registered information). For example, the VFL server may receive (e.g., from the NF), a list of VFL clients with supported ML model information for a particular (e.g., the requested) analytics service. Based on the received information (e.g., including information about supported ML models), the VFL server may select (e.g., decide, determine) a possible VFL model (e.g., one or more candidate VFL models, including a global ML model for the VFL server and local ML models for VFL clients. The VFL server may also select (e.g., based on the received information) a list of candidate VFL clients.

The VFL server may initiate sample alignment and feature alignment with the selected (e.g., candidate) VFL clients to obtain alignment results. For example, if a given sample or a given feature is unavailable for data collection at a given VFL client, the VFL server may decide to update the VFL model to remove the given sample or given feature from the global ML model and one or more local ML models determined for the VFL clients. Based on the alignment results of the sample alignment and the feature alignment, the VFL server may be configured to determine a target ML model for VFL (e.g., VFL model) for an analytics service corresponding to an analytics identifier (ID). Based on the alignment results, the VFL server may also determine (e.g., or select) a list of VFL clients (e.g., one or more VFL clients from the list of candidate VFL clients) for implementing the VFL model (e.g., performing VFL for the analytics service). The VFL server may also determine a (e.g., initial) local ML model for each VFL client. The VFL server may share information about the initial ML model for each VFL client. For instance, the VFL server may be configured to send, for each VFL client of the one or more VFL clients (e.g., selected for performing VFL for the analytics service), an indication of a local ML model determined for the VFL client.

The VFL server may also be configured to initiate a VFL training procedure (e.g., for the analytics service) with the VFL clients, for example, by communicating with the one or more VFL clients to initiate VFL training of the VFL model and by training the global ML model using local training results associated with training the one or more local ML models of the one or more VFL clients.

Examples are described herein for VFL training that involves using AF and/or NWDAF as VFL server and/or VFL client(s). The VFL server may share information about the initial ML model for each VFL client and initiate the VFL training procedure with the VFL clients as noted above. For local ML model(s), if needed, the VFL server may provide ground truth data to corresponding VFL client(s). For example, if a given VFL client does not have ground truth data for its local ML model, then the VFL server may send an indication of the ground truth data to the given VFL client.

The VFL client(s) may then perform local ML training for the local ML model(s) (e.g., indicated or determined by the VFL server). The VFL client(s) may then report interim training results (e.g., local training result(s) associated with training the local ML model(s) of the VFL client(s)). For example, the local training result(s) may include performance measurements (e.g., accuracy, etc.) and/or parameters relating to training the local ML model(s) of the VFL client(s).

The VFL server may perform global ML model training based on the local training results received from the VFL client(s). The VFL server may also decide (e.g., determine, etc.) a local ML training strategy for local ML model(s) of each VFL client (e.g., based on the global training result). The VFL server may send a request for (e.g., local) ML model update including information for updating local ML model(s) based on the determined local ML training strategy for each of the VFL clients. Thus, for example, the VFL server may be configured to send a request for updating a given local ML model of a given VFL client of the one or more VFL clients based on the global training result. Each VFL client may then update its local ML model as indicated by the VFL server and initiate local ML model training using the updated local ML model. This process may be repeated until the global ML model of the VFL server is developed to satisfy a requested performance measure (e.g., a target or configured performance threshold).

Example network analytics services are described herein. A Network Data Analytics service (e.g., feature) may provide analytics including statistics and/or predictions based on specific requests from the entities (e.g., network entities) consuming this information. Some examples of the type of information (e.g., analytics) that an analytics service (e.g., feature) provides includes statistics and/or predictions on gNB status information, gNB resource usage, and/or communication and mobility performance in an Area of Interest. The target of such analytics may (e.g., be configured to or defined to, etc.) comprise a single WTRU, a group of WTRUs, or WTRUs that may be in an Area of Interest. Furthermore, the analytics service may provide Network data analytics that characterize Network Function load, and/or Network Slice load. The analytics service may provide data analytics that include predictions and/or statistics regarding WTRU mobility and/or expected WTRU behavior. The analytics service may provide analytics such as observed service experience analytics at multiple levels (e.g., including Network Slice, service experience analytics for a particular application, and/or service experience analytics for a particular application over a particular access type (e.g., RAT type or frequency).

Examples are described herein for horizontal federated learning. Federated learning among multiple NWDAFs may be specified in the 3GPP. For example, the 3GPP may specify how NWDAF functions including model training functions can leverage Federated Learning technique to train an ML model.

For Horizontal Federated Learning, a NWDAF enabled for (e.g., capable of) federated learning may register to a network repository function (NRF) with their NF profile, information for a supported analytics service (e.g., Analytics ID(s)), Address information of NWDAF, Service Area, its capability for Federated Learning (e.g., as VFL server or as VFL client). This registered information may be utilized to identify NWDAFs (e.g., find proper NWDAF function) to join federated learning for one or more analytics services, candidate ML model(s), and/or requested service area(s).

Model Filter information may be defined to indicate the conditions when a ML model is requested for an analytics service. The model filter information may also indicate a target of the ML model, such as specific WTRU(s), a group of WTRUs, and/or any WTRU, for example.

For Horizontal Federated Learning, FL Server NWDAF and FL Client NWDAF may also be defined. When an analytics service is requested, for example, a FL server NWDAF may receive a request for federated learning with an indication of a (e.g., requested or required, etc.) ML model Accuracy. The FL Server NWDAF may then discover and/or select one or more (e.g., proper or appropriate) FL Client NWDAF(s) for the specific analytics service with requested ML model at some service area, NF types of data source(s) from which the NWDAF is to collect data for local model training, and/or an interested time period (e.g., time period of interest). The FL Server NWDAF may provide FL Client NWDAF(s) with local ML model(s) and may request FL Client NWDAF(s) to perform local model training (e.g., of the local ML model(s). Each FL Client NWDAF may then collect its local data, perform local model training with the collected local data, and report interim local ML model information (e.g., local training result(s)) to the FL Server NWDAF. The FL Server NWDAF may update a global ML model based on the aggregated local ML models and may provide the (e.g., proper, updated, etc.) global ML model for the requested analytics service.

Example use cases for vertical federated learning in 5GC are described herein. VFL is a federated learning method in which multiple parties perform training on data sets that share the same sample space but differ in feature space. Because of this characteristic, an alignment in sample and feature spaces among participating entities may be performed before applying VFL. VFL may enable example systems described herein to perform joint training without exposing raw data, for example, with each entity controlling (e.g., or owning) its own ML model. Therefore, VFL may be a more appropriate method for federated learning in some applications, such as in scenarios where privacy protection is preferred (e.g., or required or requested) among the parties performing training.

For Vertical Federated Learning, in accordance with the present disclosure, a VFL Server and VFL Client(s) may be configured as follows. The VFL Server may be a NWDAF or an AF configured to integrate local training results for the local ML model(s) to update the VFL training process. The VFL server may also coordinate the VFL training process by discovering and selecting VFL clients. In VFL inference process, for example, the VFL server may aggregate local inference results from VFL clients to generate a final VFL inference result. In this example, the VFL server may also send the final VFL inference result to the consumer. In examples, one VFL server may be employed for each VFL process. A VFL Client may be configured as a NWDAF or an AF that holds a local dataset and performs local training and/or inference according to instructions received from the VFL Server. In examples, multiple VFL Clients can be employed (e.g., with one VFL server) for VFL training and inference.

For Vertical Federated Learning in 5GC, a VFL process may be associated with an analytics ID (e.g., VFL training of models for analytics ID, VFL inference for an analytics ID), e.g., where the VFL server is a NWDAF. The NWDAF configured as the VFL Server may determine (e.g., based on internal logic and/or the operator's policy) whether or not to use VLF to provide a particular analytics service associated with a particular analytics ID.

To support VFL for analytics derivation, a VFL server may perform sample and feature alignment between the entities (e.g., VFL server, VFL clients, etc.) participating in VFL. As an example, a 5GC may provide observed service experience analytics by using VFL procedures. In this example, for observed service experience analytics service by NWDAF, for each WTRU (e.g., requested as target of the analytics service) included in the (e.g., VFL) procedure, a VFL model may be configured to process data collected from various sources. For example, to train the VFL model, service quality and/or service experience data from AF may be used as input data, network data in QoS flow level from 5GC NF may be used as input data, and/or WTRU level network (NW) data relating to the QoS profile from operations and management (OAM) may be used.

However, in some scenarios, when an NWDAF or AF (e.g., as a VFL server or as a VFL client) initiates the VFL training process (e.g., locally) for observed service experience analytics, it may be desirable that no exchange of raw data take place directly between the NWDAF and an external AF, for example, as the NWDAF may be in a public land mobile network (PLMN) and the AF may be outside the PLMN. Thus, in this scenario, this condition (e.g., sharing raw data) may compromise user data which has high privacy protection requirements.

Since NWDAF and AF may have different features of a same sample identity for local training, in some examples, the application of VFL among two such entities may be based on (e.g., or may require) alignment of samples and features. Additionally, since the inference for VFL is also a distributed inference, in some configurations, raw data may not be shared in the inference stage nor in the training stage. For example, each entity may be configured to use local data to perform the inference, and the output(s) (e.g., of the individual ML models) may then be gathered to get a final result.

Example comparisons between horizontal federated learning (HFL) and vertical federated learning (VFL) are described herein.

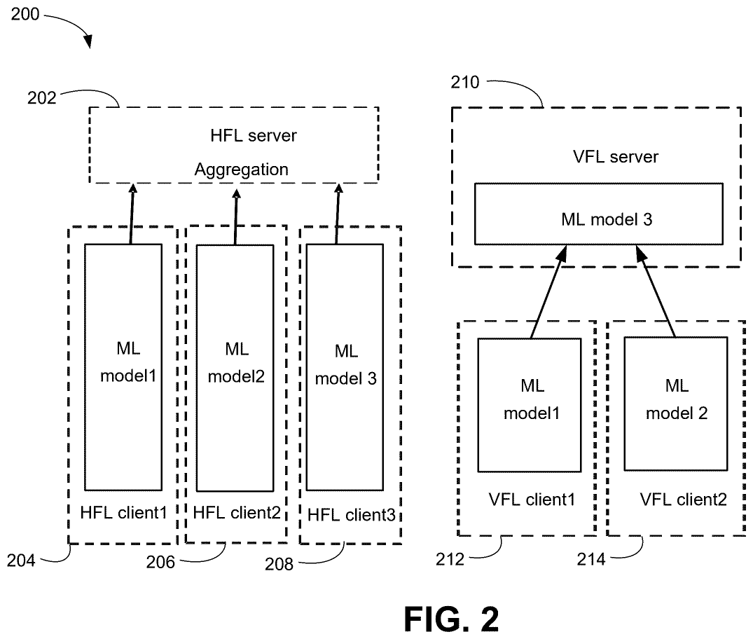

FIG. 2 is a system diagram 200 illustrating an example of HFL (e.g., HFL server 202 and HFL clients 204, 206, 208) and an example of VFL (e.g., VFL server 210 and VFL clients 212, 214). Within examples, a network element (e.g., VFL server, VFL client, etc.) may be a device comprising a processor, a memory, and/or a transceiver that are similar to, respectively, the processor 118, the memory 130, 132, and/or the transceiver 120 described above for the WTRU 102. For example, the processor may execute instructions stored in the memory to cause the network element to perform the various operations of the VFL server and/or the VFL client described herein. Example differences between HFL and FVL, for applications associated with network analytics services in 5GC, are described herein.

For HFL in 5GC, the entities involved may be within the same operator's control. Therefore, it may be assumed that for each Analytics service (e.g., identified by an Analytics ID), NWDAFs may be preconfigured with supported ML models by operators and NWDAF supporting a same Analytics ID may be configured to be able to support the same ML model. Thus, based on interoperability information, compatibility of specific file format and environment for ML models from different vendors can be verified when NWDAFs from different vendors are involved. On the other hand, for VFL in 5GC, AF and NWDAF may be involved and the supported ML models per Analytics ID may be different between AF and NWDAFs (e.g., AF may be out of control of the operator of NWDAF, etc.).

As another example, for HFL in 5GC, same ML models with same features but different sample sets may be used by FL client NWDAF(s) and same ground truth data may be available among FL client NWDAFs and FL server NWDAFs. On the other hand, for VFL training in 5GC, ML models used by each FL client NWDAF (e.g., VFL client) may have different features but same sample sets. Further, a VFL server may build a global ML model (e.g., and/or a VFL model) by integrating ML models from the VFL server and VFL clients. Therefore, the VFL server may acquire ground truth data for training the global ML model but the availability of the ground truth data for training local ML model(s) may be different for different VFL cases. For example, some VFL clients may have the ground truth data while other VFL clients may not have the (e.g., same) ground truth data.

Accordingly, the present disclosure provides solutions for technical problems in various scenarios associated with VFL for 5GC.

In a first example scenario, for an analytics ID, supported ML models at a VFL client (e.g., input, output, hyperparameter) may be preconfigured by the operator but ground truth data for a local ML model of the VFL client may only be available at the VFL server.

In a second example scenario, for an analytics ID, supported ML models at a VFL client (e.g., input, output, hyperparameter) may be preconfigured by the operator and ground truth data for the local ML model may be available to the VFL client via a NF for local data collection.

In a third example scenario, for an analytics ID, the VFL server may configure an initial ML model for local training at each VFL client (e.g., input, output, hyperparameter) and ground truth data for local ML model may be available (e.g., provided) to the VFL client (either from the VFL server or from the NF for local data collection).

In a fourth example scenario, for an analytics ID, the VFL server may configure a respective initial ML model for local training at each VFL client but ground truth data for local ML model may not be available to one or more VFL clients.

For example, when VFL is used to derive analytics for Observed Service Experience Predictions (e.g., for Video Conferencing Application) at some time and/or within certain area, Input data may be collected from one or more of AF, AMF, SMF, UPF, OAM, etc. Accordingly, the VFL client may be defined (e.g., or selected) for local ML model training using data from different Network Functions. For example, VFL_client_1 may be defined for Local ML model training with data from AF (e.g., based on application-level service experience), VFL_client_2 may be defined for local ML model training with data from AMF (e.g., based on location), VFL_client_3 may be defined for Local ML model training with data from SMF (e.g., based on packet data unit (PDU) session data and/or QoS flow identifier (QFI)), and VFL_client_4 may be defined for Local ML model training with data from OAM (e.g., based on RAN throughput).

In one scenario for VFL, each Local ML model may be trained to provide Service Experience Predictions based on each (e.g., locally) available data set (e.g., based on data from AF only, AMF only, SMF only, or OAM only). In this scenario, the VFL server may train the global ML model to provide Service Experience Prediction by merging (e.g., weighted sum) data from the local ML models (e.g., of the VFL clients). Further, in this scenario, same Ground-truth data may be used for global training and local training. For example, the VFL server may be configured to provide the same Ground-truth data to each VFL client (e.g., or to one or more VFL clients).

In another scenario for VFL, each Local ML model may be trained to provide a different output which is available from each data provider. For example, VFL_client_2 may provide predictions of the number of users/subscribers in an area of interest (e.g., at an intended area), VFL_client_3 may provide requested traffic volume prediction per NW slice level, and VFL_client_4 may provide expected RAN throughput prediction per time period. In this scenario, the Global ML model may be trained to derive a Service Experience Prediction from the trained local ML model(s) from each VFL client. For example, the VFL server may be configured to train the global ML model using local training results associated with the local ML models of the VFL clients. In this scenario, the Ground-truth data for training the local ML model(s) of the VFL clients may be provided from one or more (e.g., different) NFs.

Thus, in line with the examples above, it may be desirable for the VFL training procedure to accommodate various VFL scenarios.

Accordingly, examples described herein may enable a VFL server to handle VFL procedures according to (e.g., supporting) various VFL scenarios and/or different ML model capabilities of VFL clients, while also determining (e.g., or selecting) VFL operation(s) and/or VFL clients (e.g., to implement different VFL models), designing Global ML model and Local ML models for VFL, and/or initiating or updating various ML models while ML training with various VFL clients.

Examples are described herein for VFL capability registration of supported ML model(s) between AF and 5GC. For VFL operation, a VFL server may receive information about the supported ML models at VFL clients for an Analytics Service. When an AF is configured as a VFL server, for example, the AF may need to know the supported ML models at NWDAFs capable of being configured as VFL clients. As another example, when an NWDAF is configured as a VFL server, the NWDAF may need to know the supported ML models at other NWDAFs and/or AFs capable of being configured as VFL clients.

For VFL, examples are described herein where NWDAFs and/or AFs capable of being configured as VFL client or VFL server may register (e.g., an indication of) their capability to a NRF. For example, an AF may register its capability as an untrusted entity to the NRF via a network exposure function (NEF).

If a VFL client is configured to support a ML model and configured with information such as ML model input(s), ML model output(s), associated NF(s) for data collection, and availability of ground truth data, for example, then the VFL client may register this information (e.g., indicating its capability) at NRF as well as information about one or more other ML models supported at the VFL client. For example, if a VFL client is configured with a ML model for Observed Service Experience Predictions analytics service, the VFL client may be configured to collect data from SMF NF for a NW slice represented by a set of network slice selection assistance information (S-NSSAI); where input features (e.g., for the ML model) may include data network name (DNN), Application ID, data network access identifier (DNAI), PDU Session type, session and service continuity (SSC) Mode, Access Type, etc.; and where output features (e.g., for the ML model) may include predicted level of service experience (0 . . . max) for an Application ID, DNN, and/or DNAI. Thus, a VFL server may acquire the information for the ML model(s) supported at each VFL client by querying the NRF so that the VFL server may determine (e.g., or select) ML models for VFL based on the capability information of various possible VFL clients (e.g., registered at the NRF).

Thus, the information associated with various ML models (e.g., registered capability information) of various network elements (e.g., NWDAFs, AFs, etc.) in the wireless communication network may include (e.g., for each network element capable of being configured as VFL server or VFL client) an indication of preconfigured ML model(s), configurable ML model(s), input features, output features, associated NF(s) for data collection, availability of ground truth data, and/or ground truth data source(s), etc.

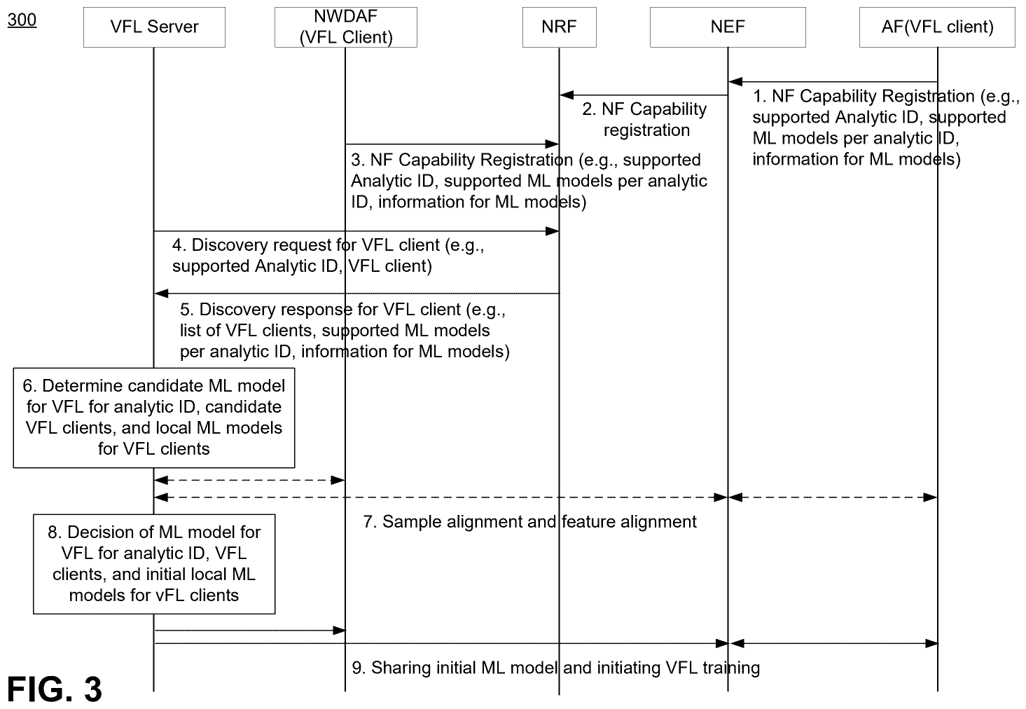

FIG. 3 is a diagram illustrating an example process 300 for VFL client capability registration including registration of information associated with supported ML models, according to an embodiment.

As illustrated in the example process 300, if an AF has a capability to operate as VFL client (e.g., can provide one or more analytics services), the AF may register information about its capability, such as an indication of supported ML models for each analytics service and/or information specific to the ML model(s) (e.g., input features, output features, etc.), for example, to NRF via NEF by sending a NF Capability Registration request. The NF capability registration request may include NF ID, NF type, service area, and/or an indication of the capability such as supported role as VFL client, supported analytics ID(s), supported analytics service(s), supported ML models per analytics ID, and/or information associated with each supported ML model (e.g., input features, output features, etc.).

When the NEF receives the NF Capability Registration request (e.g., including an indication that the AF has the capability to operate as a VFL client for one or more analytics services), the NEF may map the analytics service(s) supported by the AF (e.g., if the supported analytic service(s) are included in the request) to one or more analytics IDs (e.g., which may represent one or more analytics services provided by a NWDAF). The NEF may also register the analytics ID(s) as supported analytics service information of the AF. Further, upon receiving the NF capability registration request from the AF, the NEF may send the NF Capability registration request to the NRF. The NRF may then register the capability information of the AF (e.g., as a possible VFL client) which is accessible to the NRF via the NEF.

As illustrated, if a NWDAF also has a capability to operate as a VFL client that can support one or more analytics services represented by one or more Analytics IDs, the NWDAF may similarly register (e.g., with the NRF) information indicating its capability and the one or more analytics services associated with the NWDAF. The NWDAF may also register information indicating one or more supported ML models for each analytics service, and/or information associated with (e.g., one or more characteristics of) the supported ML models (e.g., input features, output features, etc.) to the NRF by sending a NF Capability Registration request to the NRF. The capability registration request of the NWDAF may include a NF ID, NF type, capability information such as supported role as VFL client, supported analytics ID(s), supported ML models per analytics ID, and/or other information (e.g., characteristics) associated with each supported ML model.

As illustrated, a VFL server may be triggered to perform VFL for an analytics service represented by an Analytics ID (e.g., by receiving a request from an consumer NF for the analytics service). In response to detecting the trigger to perform VFL for the analytics service, the VFL server may send a discovery request to the NRF to discover VFL clients to support VFL as VFL client for an Analytics ID. Additionally or alternatively, the discovery request may include filter information (e.g., analytics ID, ML model ID, service area, etc). For example, the NRF may provide (e.g., as a discovery response) a list of VFL client(s) satisfying the filter information.

As illustrated, the NRF may respond to the discovery request by sending a discovery response to the VFL server. The discovery response may include information indicating a list of VFL clients (e.g., NF ID, NF type), service area associated with the VFL clients, capability information of the VFL clients that satisfy the requested analytics ID, supported ML models for the analytics ID (e.g., for each compatible VFL client), information associated with the ML models. The information associated with the ML model(s) may include, for example, preconfigured ML model(s), configurable ML model(s), input features, output features, associated NF for data collection, availability of ground truth data, the source of the data, characteristics of the ML model(s), etc.

As illustrated, after receiving the list of VFL clients and an indication of their capability, the VFL server may determine candidate ML models to perform VFL for the requested analytics ID based on the supported ML models at the VFL clients, service area(s) of the VFL clients, of the ML models input features, and/or output features of the ML models. Based on the received information associated with the supported ML model(s), the VFL server may decide (e.g., determine) a possible VFL model (e.g., including a global ML model for the VFL server, and one or more local ML models for one or more VFL clients) and/or a list of candidate VFL clients to implement the VFL model (e.g., with the VFL server).

For example, if one or more of the discovered VFL clients only support preconfigured ML model with fixed input features, output features, and ground truth data (e.g., acquired) from a NF that provides data for training local ML model, then the VFL server may compose (e.g., or determine) the VFL model to include the output features of the local ML model(s) of those VFL clients as input features of the (e.g., global) ML model of the VFL server.

As another example, if one or more of the discovered VFL clients support a preconfigured ML model with output features corresponding to output features of the global ML model for the analytics ID, then the VFL serve may determine (e.g., compose) the global ML model as being configured to generate (e.g., predict) a weighted sum of (e.g., outputs from) the local ML models. In this example, the VFL server may provide the ground truth data to the VFL client(s) for local training of the local ML model(s) at the VFL client(s).

As another example, if candidate VFL client(s) (e.g., one or more of the discovered VFL clients) support a configurable ML model, the VFL server may configure the (e.g., configurable) local ML models for the candidate VFL client(s). In this example, the VFL server may provide ground truth data to the candidate VFL client(s). Alternatively or additionally, the candidate VFL client(s) may acquire the ground truth data from NF(s) configured to provide local data according to the design of local ML model.

As illustrated, the VFL server may perform sample alignment and feature alignment with the candidate VFL clients (e.g., NWDAF(s) or AF(s)) to obtain alignment results. When a NWDAF is configured as the VFL server and a NWDAF is configured as a VFL client, for example, the VFL server and the VFL client may exchange signaling directly. If either of the VFL server or the VFL client is an AF, for example, the VFL server and the VFL client may exchange signaling via NEF, as illustrated in the example process 300. For example, if a list of WTRUs is indicated for the analytics service (e.g., of the VFL model) as a sample set, the VFL server may perform a sample and/or feature alignment by checking whether input data for the indicated features of the list of WTRUs are collectable (e.g., available for data collection) by the NF associated with the VFL client(s) (e.g., in the registered capability information of the VFL client(s)). If one or more of the features are not supported by one or more of the VFL clients or if one or more of the samples (e.g., corresponding to the requested features) are not available for data collection, the VFL server may be configured to update the VFL model to drop (e.g., remove) the one or more features or the one or more samples from the (e.g., design of) the global ML model and the local ML model(s) corresponding to the VFL model.

When the NEF receives a sample alignment or feature alignment service request from the VFL server for an AF (e.g., configured to operate as a VFL client), the NEF may translate an Analytics ID into an analytics service supported by the AF (e.g., if the analytics ID is included in the request).

As illustrated, based on the alignment results of the sample alignment and feature alignment, the VFL server may determine (e.g., or update) the target ML model for VFL (e.g., the VFL model) for the analytics ID and/or (e.g., with) a list of VFL clients. For example, the VFL server may select (e.g., or update or determine) the VFL model from one or more candidate VFL models determined based on the received information, e.g., so that the VFL model includes a global ML model and one or more local ML models that are adjusted (e.g., fine-tuned, etc.) to achieve a performance threshold (e.g., accuracy requirement, etc.) associated with the requested analytics service. The VFL server may thus determine an (e.g., initial) local ML model for each VFL client (e.g., selected for the VFL model of the requested analytics service).

As illustrated, the VFL server may share information of the initial ML model (e.g., downloadable server address, ML model ID, ML model type, input feature, output features, source of ground truth data, hyperparameters, etc.) for each VFL client. For example, the VFL server may send an indication of a local ML model for each VFL client. The VFL server may initiate the VFL training procedure with VFL clients (e.g., based on the determined VFL model), for example, by communicating with the VFL clients.

Examples are described herein for VFL training that involves AFs and/or NWDFs configured as the VFL server and the VFL client(s). For VFL training, when needed, the VFL server may provide the ground truth data for local ML model training during (e.g., or as part of) the sharing of the initial ML model or after initiating VFL training (e.g., as a separate procedure).

During VFL training, for example, the VFL server may update local ML model(s) and/or coordinate ML model training based on a local ML training strategy which me be different for different VFL scenarios and/or different VFL client capabilities.

The local ML training strategy may be configured to indicate how a VFL client is to update training of local ML model to improve a target accuracy level of the global ML model. For example, the VFL server may determine the local ML training strategy to set (e.g., or adjust) an accuracy level, apply a loss function, apply different weights for multidimensional output for local ML training, apply different weights for input features, and/or preprocess raw data, etc.

For example, when a VFL client trains a local ML model training based on a preconfigured ML model and/or locally available data (e.g., including ground truth data), the VFL server may design (e.g., determine) the global ML model in consideration of preconfigured ML model information from the VFL client and apply (e.g., determine) a local ML training strategy to coordinate (e.g., or adjust) the training of the local ML model, for example, by adjusting accuracy level.

As another example, when a VFL client trains a local ML model based on a configurable ML model (e.g., configured by VFL server with ground truth data received from the VFL server), the VFL server may design (e.g., or determine) the global ML model and the local ML model (e.g., of the VFL client) based on locally available data. Further, during training for instance, the VFL server may update a design (e.g., configuration) of a loss function, accuracy and/or other characteristics of the local ML model of the VFL client.

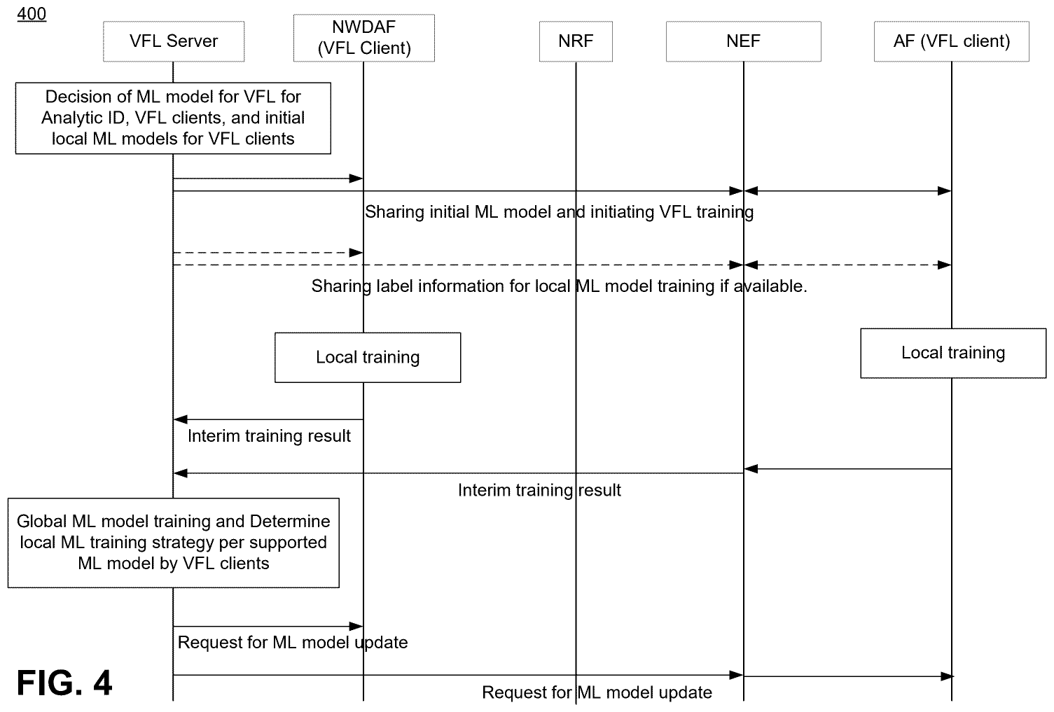

FIG. 4 is a diagram illustrating an example process 400 for VFL training with a local ML training strategy, according to an embodiment. As illustrated (step 1), the VFL server may decide VFL for analytics ID (e.g., determine a VFL model for an analytics service associated with the analytics ID), for example, by determining a global ML model, a list of one or more VFL clients, and/or a (e.g., initial) local ML model for each VFL client of the one or more VFL clients.

As illustrated (step 2), the VFL server may share information associated with the initial ML model for each VFL client. The VFL server may initiate VFL training procedure with the VFL client(s). If a VFL client is an AF, for example, the VFL server may provide (e.g., send) the (e.g., initial) ML model information determined for the VFL client and an indication to initiate VFL training to the AF through the NEF.

As illustrated (step 3), if needed, the VFL server may provide ground truth data to one or more of the VFL client(s). If a VFL client is an AF, the VFL server may send (e.g., provide) the ground truth data (e.g., or an indication thereof) to the AF through the NEF.

As illustrated (step 4), the VFL clients (e.g., including NWDAF VPL client(s) and AF VFL client(s)) may perform local ML training for their respective local ML model(s). For local training, the VFL client(s) may use ground truth data provided by the VFL server or the NF associated with local data collection for the VFL client (e.g., according to the determined local ML model and/or as indicated by VFL server).

As illustrated (step 5), the VFL client(s) (e.g., including NWDAF VFL client(s) and/or AF VFL client(s), may report interim training results (e.g., local training results) with performance measures (e.g., accuracy, etc.) and/or parameters associated with the training of the local ML model(s).

As illustrated (step 6), the VFL server may train the global ML model by integrating the received interim trained local ML models (e.g., or the local training results) and the received performance measurements associated with the training of the local ML model(s) (e.g., to obtain a global training result). Further, based on (e.g., the global) training result, the VFL server may decide (e.g., or determine) a local ML training strategy for the local ML models of each VFL client. For example, the VFL server may be configured to adjust a given local ML model of a given VFL client (e.g., based on the global training result), for example, to improve a performance metric.

As illustrated (step 7), if needed, the VFL server may send a request for ML model update including information for updating one or more local ML models (e.g., input, output, loss function, requested accuracy, etc.) corresponding to one or more (e.g., or each) VFL clients based on the determined local ML training strategy.

As illustrated (step 8), one or more (or each) VFL client may update its local ML model as indicated by the VFL server and may initiate local ML model training using the updated local ML model.

In some examples, steps 4 to 8 may be repeated until the global ML model is developed to satisfy a requested performance measure.

1. A method performed by a vertical federated learning (VFL) server in a wireless communication network, the method comprising:
receiving information indicating: (i) a plurality of network elements associated with one or more analytics services, and (ii) respective machine learning (ML) models supported at the plurality of network elements for the one or more analytics services;
based on the received information, selecting one or more of the plurality of network elements as one or more VFL clients to perform VFL for an analytics service;
performing sample and feature alignment with the one or more VFL clients to obtain alignment results;
based on the alignment results, determining a VFL model for the analytics service, the VFL model including a global ML model determined for the VFL server and one or more local ML models determined for the one or more VFL clients; and
for each VFL client of the one or more VFL clients, sending an indication of a local ML model determined for the VFL client.

2. The method of claim 1, wherein a network element of the plurality of network elements is configured to implement a network data analytics function (NWDAF) or an application function (AF) in the wireless communication network.

3. The method of claim 1, wherein the VFL server is a network element configured to implement a network data analytics function (NWDAF) or an application function (AF) in the wireless communication network.

4. The method of claim 1, further comprising:
detecting a trigger to perform VFL for the analytics service; and
in response to detecting the trigger, sending a discovery request to receive the information indicating the plurality of network elements as a discovery response.

5. The method of claim 1, further comprising:
based on the alignment results indicating that a given sample or a given feature is unavailable for data collection at a given VFL client of the one or more VFL clients, updating the VFL model to remove the given sample or the given feature from the global ML model and the one or more local ML models.

6. The method of claim 1, further comprising:
sending, to a given VFL client of the one or more VFL clients, an indication of ground truth data for training a given local ML model of the given VFL client.

7. The method of claim 1, further comprising:
communicating with the one or more VFL clients to initiate VFL training of the VFL model.

8. The method of claim 1, further comprising:
receiving, from the one or more VFL clients, local training results associated with training of the one or more local ML models;
training the global ML model using the local training results to obtain a global training result; and
based on the global training result, sending a request for updating a given local ML model of a given VFL client of the one or more VFL clients.

9. The method of claim 1, wherein the received information further indicates one or more characteristics of the respective ML models.

10. The method of claim 1, further comprising:
based on the received information, determining one or more candidate VFL models for the analytics service, wherein determining the VFL model is further based on the determined one or more candidate VFL models.

11. The method of claim 1, wherein the analytics service is configured to provide analytics associated with the wireless communication network.

12. The method of claim 11, wherein the analytics include network data analytics that characterize network function load or network slice load.

13. The method of claim 11, wherein the analytics include observed service experience analytics for a particular application.

14. The method of claim 11, wherein the analytics include statistics or predictions based on network data collected in the wireless communication network.

15. The method of claim 14, wherein the statistics or predictions are associated with at least one of: base station status information, base station resource usage, communication and mobility performance in an area of interest, wireless transmit/receive unit (WTRU) mobility, or expected WTRU behavior.

16. A vertical federated learning (VFL) server in a wireless communication network, the VFL server comprising:
a processor configured to:
receive information indicating: (i) a plurality of network elements associated with one or more analytics services, and (ii) respective machine learning (ML) models supported at the plurality of network elements for the one or more analytics services;
based on the received information, select one or more of the plurality of network elements as one or more VFL clients to perform VFL for an analytics service;
perform sample and feature alignment with the one or more VFL clients to obtain alignment results;
based on the alignment results, determine a VFL model for the analytics service, the VFL model including a global ML model determined for the VFL server and one or more local ML models determined for the one or more VFL clients; and
for each VFL client of the one or more VFL clients, send an indication of a local ML model determined for the VFL client.

17. The VFL server of claim 16, wherein a network element of the plurality of network elements is configured to implement a network data analytics function (NWDAF) or an application function (AF) in the wireless communication network.

18. The VFL server of claim 16, wherein the VFL server is a network element configured to implement a network data analytics function (NWDAF) or an application function (AF) in the wireless communication network.

19. The VFL server of claim 16, wherein the processor is further configured to:
detect a trigger to perform VFL for the analytics service; and
send, in response to detecting the trigger, a discovery request to receive the information indicating the plurality of network elements as a discovery response.

20. The VFL server of claim 16, wherein the processor is further configured to:
based on the alignment results indicating that a given sample or a given feature is unavailable for data collection at a given VFL client of the one or more VFL clients, update the VFL model to remove the given sample or the given feature from the global ML model and the one or more local ML models.
